(19) United States
(12) Patent Application Publication
(10) Pub. No.: US 2025/0362885 A1
(43) Pub. Date: Nov. 27, 2025

(54) SYSTEMS AND METHODS FOR GENERATING CODE OUTPUT

(71) Applicant: Salesforce, Inc., San Francisco, CA (US)

(72) Inventors: Yun Peng, Singapore (SG); Akhilesh Deepak Gotmare, Singapore (SG); Doyen Sahoo, Singapore (SG); Caiming Xiong, Menlo Park, CA (US); Silvio Savarese, Palo Alto, CA (US)

(21) Appl. No.: 18/904,986

(22) Filed: Oct. 2, 2024

Related U.S. Application Data
(60) Provisional application No. 63/650,732, filed on May 22, 2024.

(51) Int. Cl. G06F 8/30; G06F 8/10

(52) U.S. Cl. CPC G06F 8/30; G06F 8/10

(57) ABSTRACT

A method of generating a code output in response to a natural language problem description. The method includes: receiving the natural language problem description; generating, by a neural network based language model, a first candidate code snippet based on a first input prompt combining the natural language problem description and a first instruction; executing, at a code execution environment, the first candidate code snippet based on a unit test thereby producing a first feedback reflecting a correctness of the first candidate code snippet; generating, by the neural network based language model, a second candidate code snippet based on a second input prompt combining the natural language problem description, the first candidate code snippet, and the first feedback; and executing, at the code execution environment, the second candidate code snippet based on a runtime test thereby producing a second feedback reflecting a runtime efficiency of the second candidate code snippet.

### CROSS REFERENCE(S)

The instant application is a nonprovisional of and claim priority under 35 U.S.C. 119 to U.S. provisional application No. 63/650,732, filed May 22, 2024, which is hereby expressly incorporated by reference herein in its entirety.

### TECHNICAL FIELD

The embodiments relate generally to machine learning systems for code generation, and more specifically to systems and methods for generating code output.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. Some language models (e.g., large language models or LLMs) can be used for assisting code generation from a natural language input describing a query or an issue, e.g., a code snippet to be executed to resolve a network connection issue, etc. However, code generated by LLMs, even if correct, might not be computationally efficient in an execution environment. For example, when programming code is generated to implement to resolve a network traffic overload issue at a gateway, inefficient code may slow down the routing process and thus impairs network performance.

### BRIEF DESCRIPTION OF THE DRAWINGS

FIG. 1 is a simplified diagram illustrating a code generation framework, according to some embodiments.

FIG. 2A is a simplified diagram illustrating a computing device implementing the code generation framework described in FIG. 1, according to some embodiments.

FIG. 2B is a simplified diagram illustrating a neural network structure, according to some embodiments.

FIG. 3 is a simplified block diagram of a networked system suitable for implementing the code generation framework described in FIGS. 1, 2A, and 2B and other embodiments described herein.

FIGS. 4A-4E show exemplary prompts used for the code generation framework, according to some embodiments.

FIG. 5 is an example logic flow diagram illustrating a method of code generation based on the framework shown in FIGS. 1, 2A, 2B, and 3, according to some embodiments.

FIGS. 6A, 6B, and 7-9 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software- based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

### Overview

Language models are now widely used for code completion/generation. A user can provide instructions to a language model, so that it can generate a code snippet with desired functions and programming language. However, existing evaluation of the code snippets generated by language models often focuses only on functional correctness, but includes few or no metrics for code quality. On the other hand, runtime efficiency of a program is an important consideration in software design decisions, due to its significant impact on user experience, serving costs, and carbon footprint of a software application. For example, when the code is generated to implement to resolve a network traffic overload issue at a gateway, inefficient code may slow down the routing process and thus impairs network performance.

Existing ways to generate code using language models often include training/fine-tuning the language model. However, the existing methods are costly and lack consideration of execution feedback, which often provides information on the runtime behavior and performance characteristics of the code. As a result, the code generated using existing methods can be undesirably low efficiency.

In view of the need for ways to generate code with not only correctness but also high efficiency, embodiments described herein provide systems and methods for an neural network based code generation framework generating a code output from a natural language input and based on execution feedback at an environment to improve computational efficiency. The code generation framework includes a large language model (LLM) and a code execution environment, such as a hardware or software based simulator, and/or the like. First, the LLM may receive an input prompt comprising a text description (e.g., of an issue, or a function a code is intended to achieve) and an instruction for the LLM to generate a candidate code snippet output. The generated candidate code snippet snippet is passed to an execution environment, which generates a first execution feedback regarding the correctness of the candidate code snippet snippet, compared with the original problem description. The first execution feedback is used by the LLM to evaluate whether the candidate code snippet snippet needs to be amended to pass a correctness test. Based on the first execution feedback, a second input prompt combining the original problem description, the candidate code snippet output, and the first execution feedback to the LLM to generate an refined code snippet.

The refined candidate code snippet snippet is then passed to the execution environment again, which generates a second execution feedback regarding the run-time efficiency of the refined code snippet. The second execution feedback is used by the LLM to evaluate whether the candidate code snippet snippet is desirably efficient. Based on the second execution feedback, a third input prompt combining the original problem description, the refined candidate code snippet output and the second execution feedback is fed to the LLM to generate a code output with improved efficiency. In this way, the refining process may be performed iteratively to improve the code efficiency and correctness based on execution feedback at an execution environment.

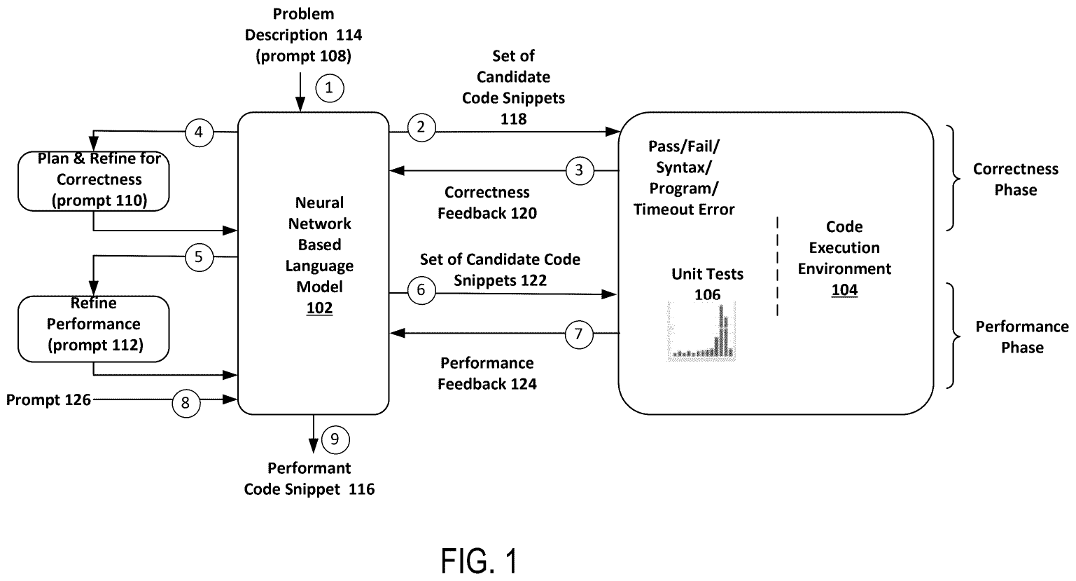

The neural network based code generation framework improves AI technology in automatic code generation and software engineering. For example, code generated by a LLM, while maintaining its functional correctness, can have improved efficiency, and the likelihood of generating an optimally efficient code is increased, as shown in FIGS. 1, 6A, 6B, and 7-9. The generated code can be used in a variety of applications such as network issue diagnostics so as to improve the quality of implementation in these technical fields. Therefore, with improved performance on code generation, AI assisted technology in various practical applications such as healthcare, network issue diagnostics, and/or the like is improved.

FIG. 1 is a simplified diagram illustrating a code generation framework 100 according to some embodiments. Code generation framework 100 may include a neural network based language model 102 and a code execution environment 102, operatively connected to each other. Neural network based language model 102 may include a suitable LLM of varying sizes, such as Phi, Llama, Mixtral, Command R, GPT-3.5, GPT-4, etc. Code execution environment 104 may include a software and/or a hardware environment such as a software development environment, a simulated network environment, and/or the like. A set of unit tests 106 may be conducted at the code execution environment 104 for evaluating the functional correctness and efficiency of code generated by neural network based language model 102. The generation of a performant/final code snippet by code generation framework 100 for problem description 114, with functional correctness and optimized efficiency, can include a correctness phase and a performance phase. A code candidate is verified for its functional correctness in the correctness phase, and can then be refined for higher efficiency in the performance phase. Detailed description of generating code using framework 100 of neural network based language model 102 and code execution environment 104 is described as follows.

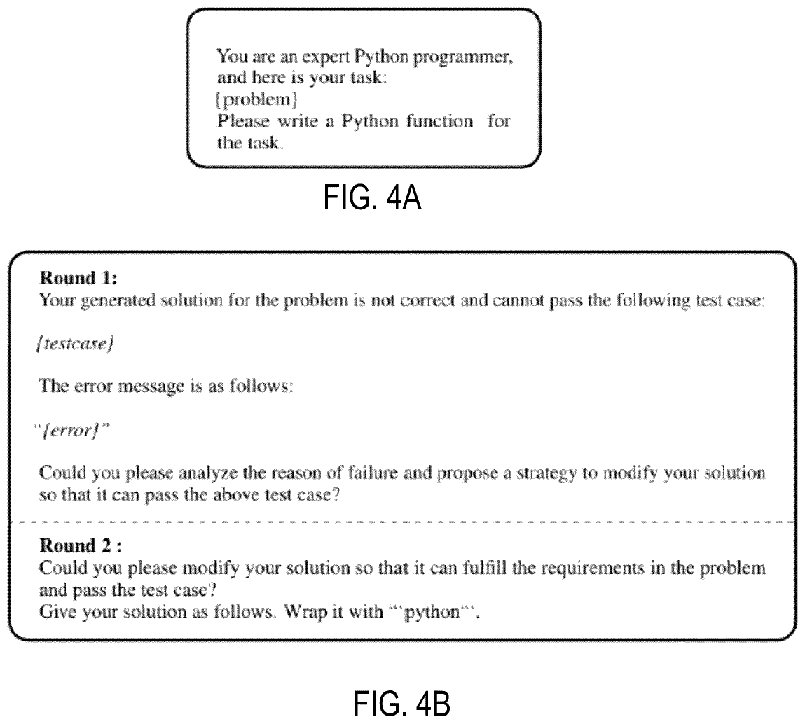

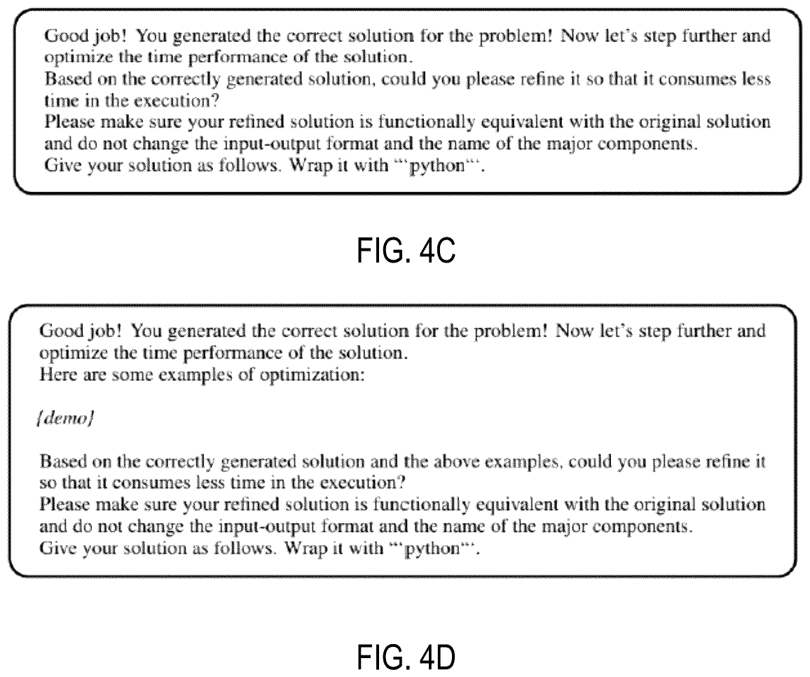

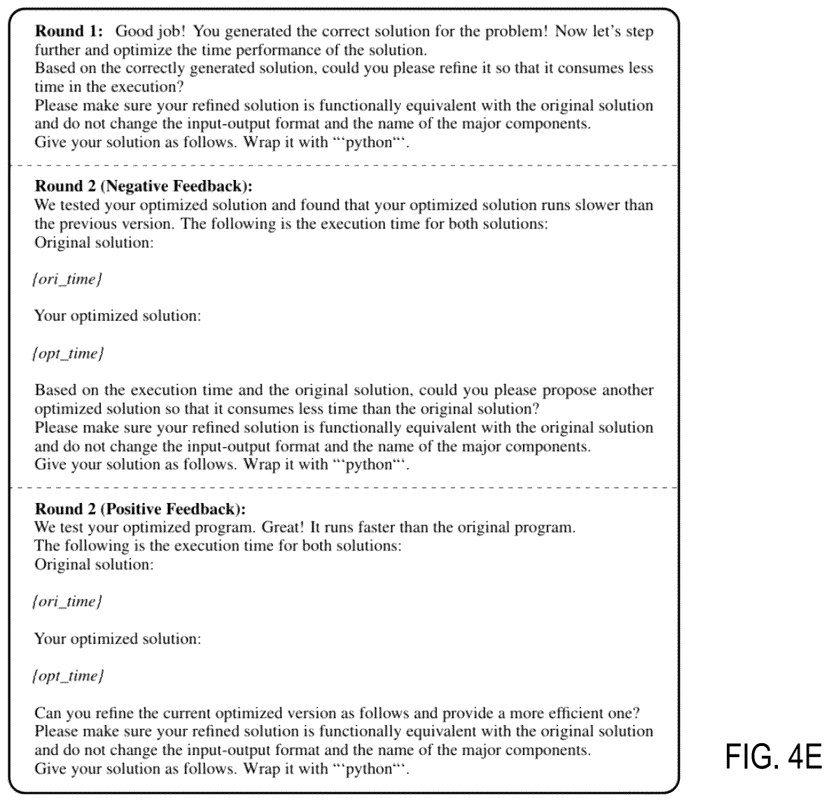

At step 1, neural network based language model 102 may receive a problem description 114 and a prompt 108 as an input, both in natural language. Prompt 108 may include an instruction that causes neural network based language model 102 to generate an output, i.e., a set of candidate code snippets 118 (e.g., a set of one or more candidate code snippets or candidate solutions). FIG. 4A shows an example of the input, which includes problem description 114, and prompt 108 of “Please write a Python function for the task.” In some embodiments, problem description 114 may include a description of a network issue, and the task may include generating a code output (e.g., a performant code snippet) to diagnose the network issue. In some embodiments, problem description 114 includes a natural language problem description that includes a description of detecting a network anomaly amongst incoming packets.

At step 2, set of candidate code snippet 118 may be passed to code execution environment 104 to evaluate its functional correctness. In some embodiments, it is assumed that set of candidate code snippets 118 includes a set

$$C = {\{ {y}_{x}^{i} \}}_{i = 1 , … , K}$$

of candidate code snippets. A set of unit tests 106 may be used. For example, a unit test may include testing inputs for a candidate code snippet, and expected values for comparing with the testing output of the candidate code snippet to determine the accuracy/correctness of the candidate code snippet.

In some embodiments, the set of unit tests 106 includes/unit

$$U ( x ) = {\{ {u}_{x}^{j} \}}_{j = 1}^{J} .$$

In some embodiments, for each unit test, set of candidate code snippet 118 is executed based on one or more testing inputs to generate one or more testing outputs. The testing outputs may each be compared to an expected value. If the testing outputs match the expected values (or the difference between a testing output and the respective expected value is within a predetermined range), it is determined that one or more in set of candidate code snippet 118 pass(es) the unit test. If the difference between a testing output and the respective expected value deviates from the predetermined range, it is determined that one or more in set of candidate code snippet 118 fail(s) the unit test.

At step 3, code execution environment 104 may generate and transmit a correctness feedback 120 to neural network based language model 102. If one or more in set of candidate code snippet 118 pass(es) each of unit tests 106, the respective correctness feedback 120 may be a positive feedback that includes a pass of unit tests 106 by set of candidate code snippet 118. If one or more in set of candidate code snippet 118 fail(s) unit tests 106, correctness feedback 120 may be a negative feedback that includes description/notification of an execution failure, a syntax error, a program error, and/or a timeout error of unit tests 106. In some embodiments, if one or more in set of candidate code snippet 118 fails unit tests 106, the respective correctness feedback 120 includes one or more of the failed unit test.

If one or more set of candidate code snippet 118 fails unit tests 106, neural network based language model 102 may receive an input that includes problem description 114, a prompt 110 that includes the instruction of “plan and refine for correctness,” and correctness feedback 120 at step 4. In some embodiments, prompt 110 includes the instruction that may cause neural network based language model 102 to self-reflect on correctness feedback 120, and update/correct the one or more in set of candidate code snippets 118 as an output. The updated/corrected one or more in set of candidate code snippet 118 may then be passed to code execution environment for correctness evaluation (e.g., be executed based on unit tests 106), and code execution environment 104 may provide an updated first feedback for neural network based language model 102 to self-reflect on, similar to set of candidate code snippet 118. In some embodiments, steps 2, 3, and 4 may be referred to as part of the correctness phase, and may be performed repeatedly until the one or more in set of candidate code snippet 118 passes each of unit tests 106. FIG. 4B shows examples of the input. As shown FIG. 4B, steps 2, 3, and 4 may be iterated at least three times (e.g., Round 1 and Round 2) to update/correct the one or more in set of candidate code snippet 118 based on the negative correctness feedback. In some embodiments, if any in set of candidate code snippets 118 (e.g., for any

$${y}_{x}^{i} ∈ C )$$

does not pass unit tests 106 after a predefined quantity of regeneration, the candidate code snippet may be removed from set C. A set C_{correct} can be formed with candidate code snippets 118 (and their refined versions for correctness) that pass unit tests 106.

When set of candidate code snippet 118 passes unit tests 106, neural network based language model 102 may receive an input that includes problem description 114, a prompt 112, and correctness feedback 120 (e.g., with a notification of a pass of unit tests 106) at step 5. Prompt 112 may cause neural network based language model 102 to refine the set of candidate code snippet 118 (e.g., the correct code) to have higher efficiency while maintaining its function, and generate a set of candidate code snippets 122 as an output. Set of candidate code snippets 122 may include one or more candidate code snippets for performance refinement. FIG. 4C shows an example of prompt 112 as part of the input. FIG. 4D shows another example of prompt 112 that includes in-context (few-shot) learning.

At step 6, set of candidate code snippets 122 may be passed to code execution environment 104. Set of candidate code snippets 122 may be executed based on a runtime test that measures an execution time consumed by set of candidate code snippets 122 to pass each of unit tests 106. In some embodiments, the execution time consumed by each one in set of candidate code snippets 122 is measured. In some embodiments, to determine the execution time consumed by each one in set of candidate code snippets 122 and a respective unit test, a plurality of independent executions are performed to obtain a plurality of observations. An empirical estimate of the expected execution time of a respective one in set of candidate code snippets 122 on the unit test may be computed as

$$\hat{t} ( {y}_{x}^{i} , {u}_{x}^{i} ) = \frac{1}{( E - 2 )} {\sum }_{e = 2}^{E - 1} t ( {y}_{x}^{i} , {u}_{x}^{i} ) [ e ] ; {u}_{x}^{f} = arg {max}_{{u}_{x}^{i}} \hat{t} ( {y}_{x}^{i} , {u}_{x}^{i} ) \qquad ( 1 )$$

where E represents the number of independent observations, x represents the problem description,

$${y}_{x}^{i}$$

represents an i-th candidate code snippet of the K initial ones in set of candidate code snippet 118 prior to correctness verification,

$$t ( {y}_{x}^{i} , {u}_{x}^{j} )$$

represents the e-th smallest execution time consumed by

$${y}_{x}^{i}$$

on the J-th unit test

$${u}_{x}^{j} .$$

The smallest and largest execution times are excluded. As an example, it is assumed that the f-th unit test

$${u}_{x}^{f}$$

corresponds to the largest execution time.

At step 7, code execution environment 104 may generate and transmit a performance feedback 124 to neural network based language model 102. Performance feedback 124 may include a runtime efficiency metric of one or more in set of candidate code snippet 122. In some embodiments, performance feedback 124 includes the unit test that corresponds to the largest expected execution time as computed in equation (1).

Step 5 may then be performed again, such that neural network based language model 102 may receive an input including a prompt 112 that includes problem description 114, one or more in set of candidate code snippets 122, and performance feedback 124. Prompt 112 may cause neural network based language model 102 to further refine the one or more in set of candidate code snippets 122. In some embodiments, a refined candidate code snippet from one in set of candidate code snippets 122 is denoted as

$${\tilde{y}}_{x}^{i} .$$

Steps 6 and 7 may be repeated, and set of candidate code snippets 122 (after refinement/update)

$$\{ {\tilde{y}}_{x}^{i} \vert {\tilde{y}}_{x}^{i}$$

passes correctness}_{i=1, . . . ,K} may be executed in code execution environment 104 to obtain performance feedback 124 for each candidate code snippet 122. In some embodiments, set of candidate code snippets 122 (after refinement) may be executed based on unit tests 106 to verify/revalidate their functional correctness. Code execution environment 104 may perform/repeat step 3 to transmit a correctness feedback 120 reflecting the functional correctness of each in set of candidate code snippets 122 (after refinement).

Based on performance feedback 124 and correctness feedback 120, respectively on the efficiency and functional correctness of each in set of candidate code snippets 122 (after refinement), neural network based language model 102 may receive an input that includes a prompt 126 combining problem description 114, set of candidate code snippets 122, performance feedback 124, and optionally correctness feedback 120. Prompt 126 may cause neural network based language model 102 to perform step 9, in which neural network based language model 102 outputs the fastest one amongst the refined candidate code snippet in set of candidate code snippets 122 that pass unit tests 106. as the performant code snippet 116 (e.g., the code output corresponding to problem description 114).

In some embodiments, the executing of performant code snippet 116 at an application associated with problem description 114 includes identifying one or more malicious network packets from an incoming network traffic based on an execution of the third candidate code snippet at a gateway application, and filtering the identified one or more malicious network packets at the gateway application.

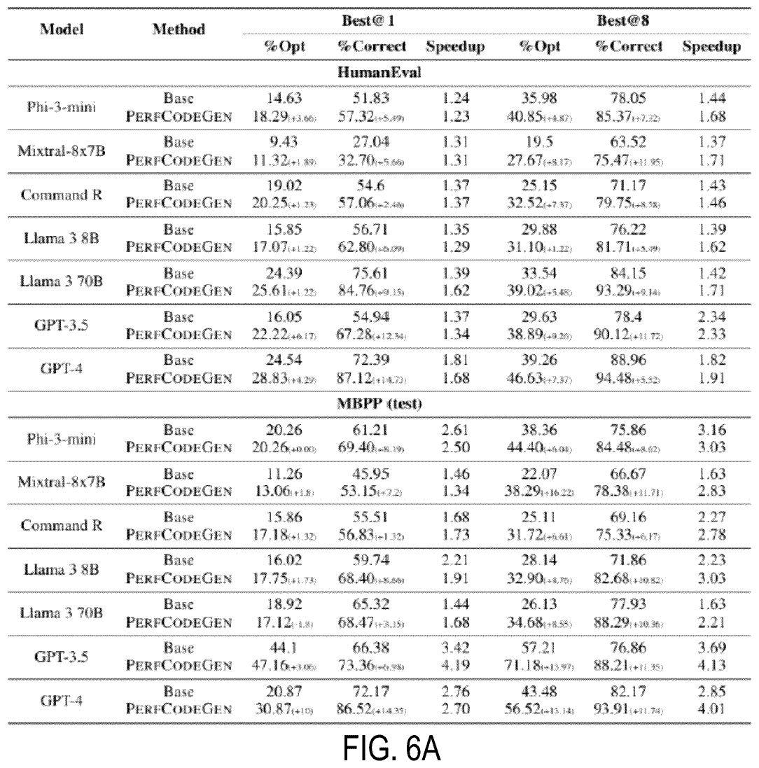

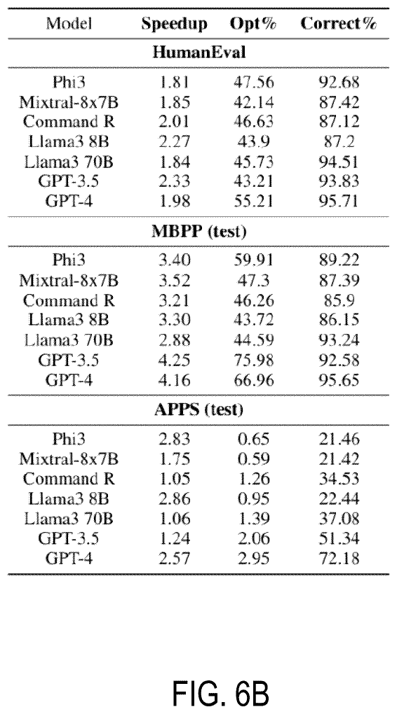

In some embodiments, steps 5, 6, and 7, part of the performance phase, are repeated until one or more in set of candidate code snippets 122 reaches a desired runtime efficiency (e.g., the largest execution time of being smaller than a predetermine value) or after a predefined quantity of regenerations. FIG. 6E shows an example of prompt 112 that includes causing neural network based language model 102 to repeat the refinement phase multiple times to increase the runtime efficiency of set of candidate code snippets 122.

If none in set of candidate code snippets 122 (after refinement) pass unit tests 106 after a pre-defined quantity of regenerations, as reflected in correctness feedback 120, neural network based language model 102 may receive an input that includes a prompt combining problem description 114 and the description of set of candidate code snippets 118 that passed unit tests 106 (before performance phase or set C_{correct}). The prompt may cause neural network based language model 102 to retrieve/regenerate the set of candidate code snippets 118 and transmit the set to be executed in code execution environment 104 to perform a runtime test. Each in set of candidate code snippets 118 may be executed based on unit tests 106, and an estimate of the expected execution time by each in set of candidate code snippets 118, corresponding to a respective unit test 106, can be calculated equation (1). Code execution environment 104 may provide a performance feedback that includes an estimate of the expected time of each in set of candidate code snippets 118. In some embodiments, prompt 126 may combine the problem description 114 and the performance feedback to output the fastest one in set C_{correct} as performant code snippet 116 (the code output corresponding to problem description 114).

In various embodiments, performant code snippet 116 is executed at a suitable application associated with natural language problem description 114. For example, performant code snippet 116 can be executed in a network issue diagnostic application.

### Computer and Network Environment

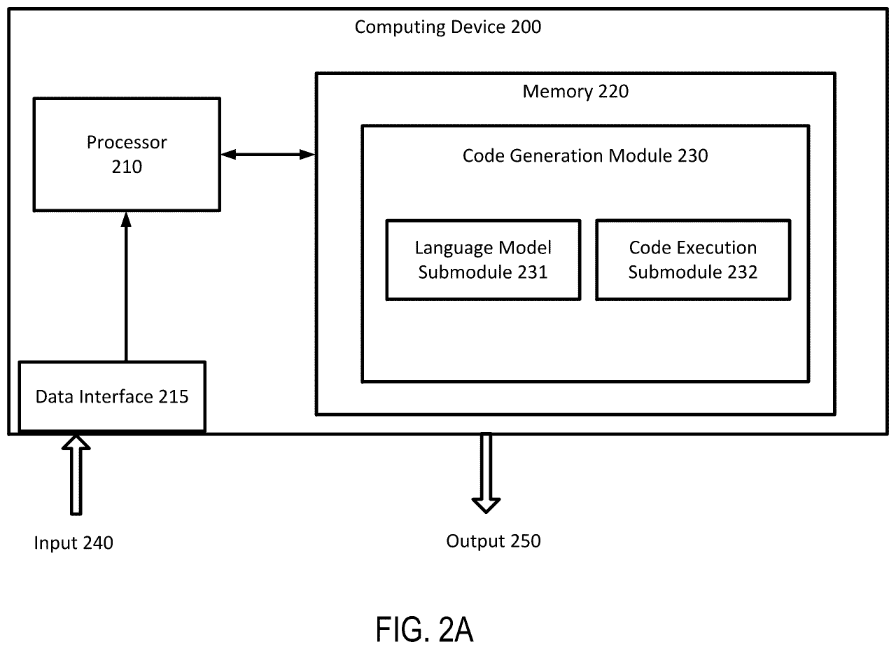

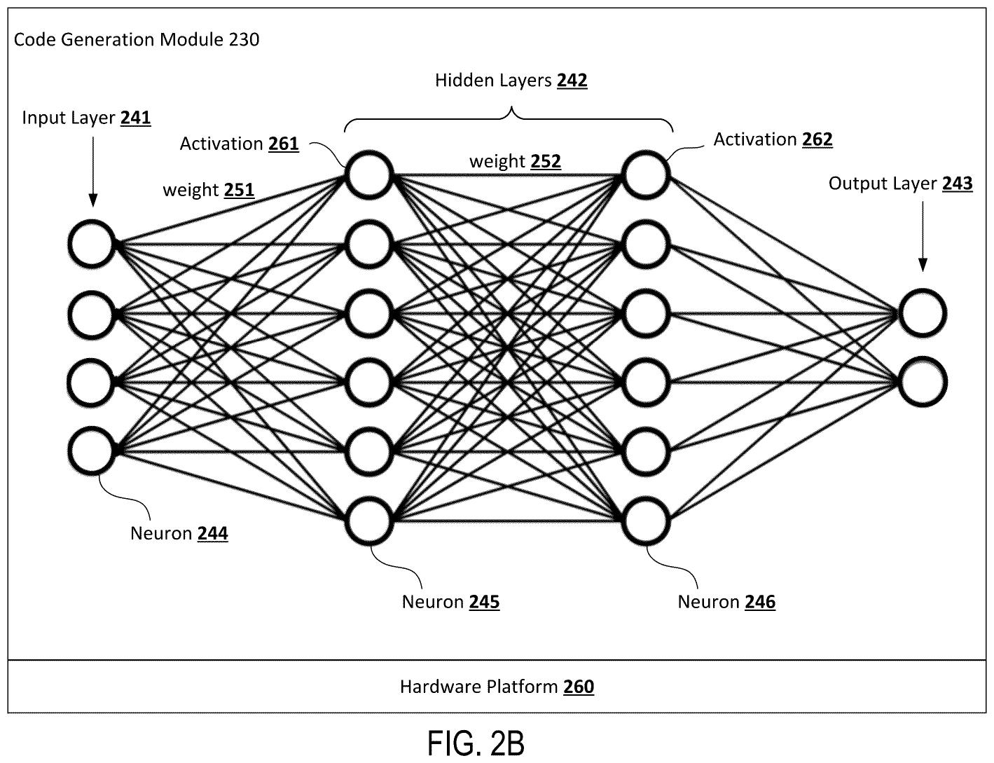

FIG. 2A is a simplified diagram illustrating a computing device implementing the code generation framework 100 described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In another embodiment, processor 210 may comprise multiple microprocessors and/or memory 220 may comprise multiple registers and/or other memory elements such that processor 210 and/or memory 220 may be arranged in the form of a hardware-based neural network, as further described in FIG. 2B.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for code generation module 230 that may be used to implement and/or emulate the systems and models, and/or to implement any of the methods described further herein. Code generation module 230 may receive input 240 such as an input training data (e.g., a prompt combining a problem description, an execution feedback, and optionally, one or more unit tests) via the data interface 215 and generate an output 250 which may be a performant code snippet to be used in an application.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as a prompt combining a problem description, an execution feedback, and optionally, one or more unit tests, from a user via the user interface.

In some embodiments, the code generation module 230 is configured to generate a performant code snippet with functional correctness and desirable runtime efficiency. The code generation module 230 may further include a language model submodule 231 and a code execution submodule 232. Language model submodule 231 may be similar to neural network based language model 102 in FIG. 1, and code execution submodule 232 may be similar to code execution environment 104 in FIG. 1.

Language model submodule 231 may be configured to generate and refine code snippets based on prompts. In some embodiments, the prompts include execution feedback (e.g., correctness feedback 120 and performance feedback 124 in FIG. 1). In some embodiments, language model submodule 231 updates/refines code snippets for improved correctness based on the execution feedback. In some embodiments, language model submodule 231 refine the correct code snippets for improved runtime efficiency. In some embodiments, language model submodule 231 generates the performant code snippet for use in an application. In some embodiments, language model submodule 231 includes a neural network based language model such as Phi, Llama, Mixtral, Command R, GPT-3.5, GPT-4, etc.

Code execution submodule 232 may be configured to execute candidate code snippets (e.g., candidate code snippets 118, 122, and their updated/refined versions in FIG. 1) based on unit tests (e.g., unit tests 106), and provide execution feedback (e.g., correctness feedback 120 and performance feedback 124 in FIG. 1) for the candidate code snippets. Correct feedback 120 may include the verification results of the functional correctness of a code snippet. For example, correct feedback 120 may include a pass of the unit tests, an execution failure, a syntax error, a program error, or a timeout error of the unit tests, etc., by a candidate code snippet. Performance feedback 124 may include a runtime efficiency of a candidate code snippet, such as the empirical estimate expected execution time of a unit test by the candidate code snippet. In some embodiments, code execution submodule 232 includes a hardware environment based on one or more of a central processing unit (CPU), a graphics processing unit (GPU), or an application specific integrated circuit (ASIC).

It is to be noted that submodules 231 and 232 may not be housed on the same computing device 200, and may be implemented at different servers accessible via a communication network.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the code generation module 230 described in FIG. 2A, according to some embodiments. In some embodiments, the code generation module 230 and/or one or more of its submodules 231 and 232 may be implemented at least partially via an artificial neural network structure shown in FIG. 2B. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as a prompt combining a problem description, an execution feedback, and optionally, one or more unit tests. The number of nodes (neurons) in the input layer 241 may be determined by the dimensionality of the input data (e.g., the length of a vector of the prompt as part of the input). Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the code generation module 230 receives an input 240 of a prompt combining a problem description, an execution feedback, and optionally, one or more unit tests and transforms the input into an output 250 of a performant code snippet to be used in an application. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code generation module 230 and/or one or more of its submodules 231 and 232 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be Phi, Llama, Mixtral, Command R, GPT-3.5, GPT-4, and/or the like.

In one embodiment, the code generation module 230 and its submodules 231 and 232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the code generation module 230 and its submodules 231 and 232 may be implemented by hardware, software and/or a combination thereof. For example, the code generation module 230 and its submodules 231 and 232 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In another embodiment, some or all of layers 241, 242, 243 and/or neurons 242, 245, 246, and operations there between such as activations 261, 262, and/or the like, of the code generation module 230 and its submodules 231 and 232 may be realized via one or more ASICs. For example, each neuron 242, 245 and 246 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the code generation module 230 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based code generation module 230 and one or more of its submodules 231 and 232 may be trained by iteratively updating the underlying parameters (e.g., weights 251, 252, etc., bias parameters and/or coefficients in the activation functions 261, 262 associated with neurons) of the neural network. For example, during forward propagation, the training data such as a prompt combining a problem description, an execution feedback, and optionally a unit test, are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth”) from the training data, to compute a loss function that measures the discrepancy between the predicted output and the expected output. For example, the loss function may be cross entropy, minimum mean square error (MMSE), or a combination thereof. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based code generation module 230 and one or more of its submodules 231 and 232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

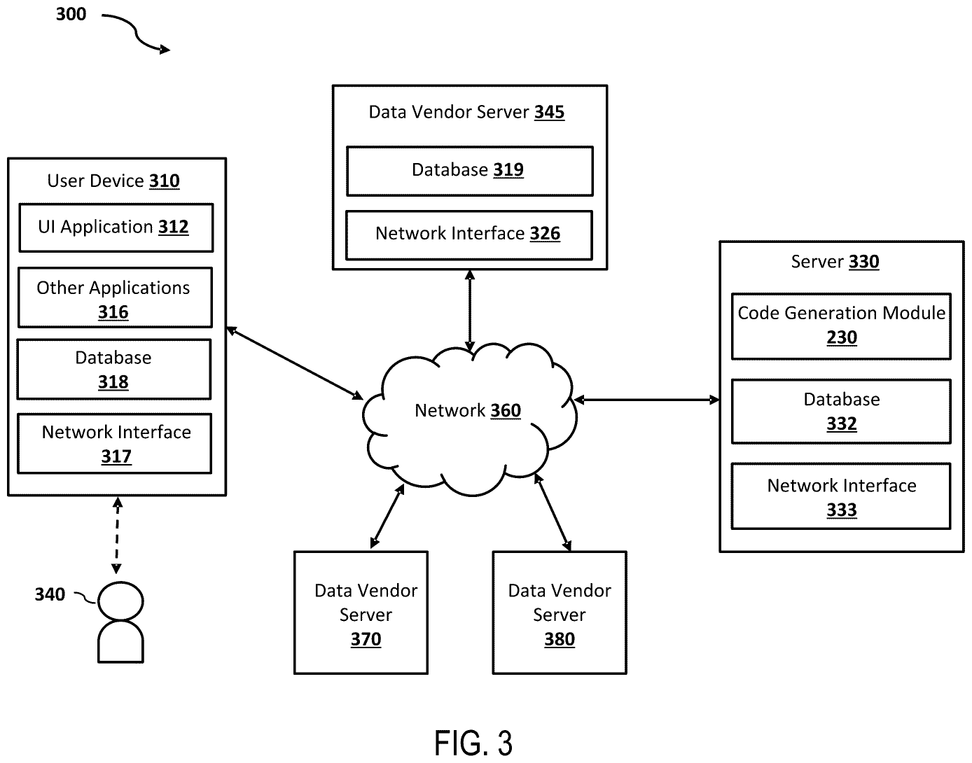

In one embodiment, code generation module 230 and its submodules 231 and 232 may be housed at a centralized server (e.g., computing device 200) or one or more distributed servers. For example, one or more of code generation module 230 and its submodules 231 and 232 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as using the generated performant code snippet to detect/diagnose a network issue.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in code generation and network issue diagnosis.

FIG. 3 is a simplified block diagram of a networked system 300 suitable for implementing the code generation framework 100 described in FIGS. 1, 2A, and 2B and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating a network issue is diagnosed using the generated performant code snippet from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the code generation module 230 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which code generation module 230 may generate a response via the process described in FIGS. 1, 2A, and 2B. The code generation module 230 may thus cause a display of diagnosed network issues at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view the diagnosed network issues.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including functionally correct and high-efficiency code snippets to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the code generation module 230 and its submodules described in FIG. 2A. In some implementations, code generation module 230 may receive data from database 319 at the data vendor server 345 via the network 360 to generate the performant code snippet for network issues diagnosis. The generated performant code snippet may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the code generation module 230. In one implementation, the database 332 may store previously generated performant code snippets, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

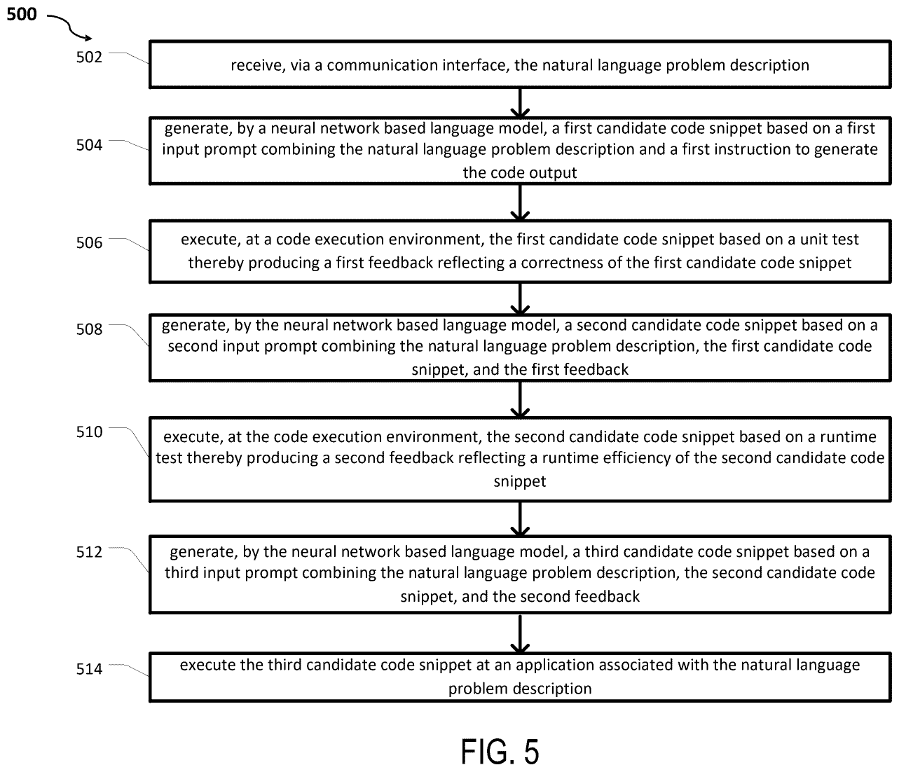

FIG. 5 is an example logic flow diagram illustrating a method of code generation based on the framework shown in FIGS. 1, 2A, 2B, and 3, according to some embodiments described herein. One or more of the processes of method 500 may be implemented, at least in part, in the form of executable code stored on non-transitory, tangible, machine- readable media that when run by one or more processors may cause the one or more processors to perform one or more of the processes. In some embodiments, method 500 corresponds to the operation of the code generation module 230 (e.g., FIGS. 2A and 3) that performs the generation of a performant code snippet for an application.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, receiving, via a communication interface (e.g., data face 215), the natural language problem description (e.g., problem description 114).

At step 504, a neural network based language model (e.g., neural network based language model 102) generates a first candidate code snippet (e.g., set of candidate code snippet 118) based on a first input prompt combining the natural language problem description and a first instruction to generate the code output (e.g., at step 1).

At step 506, the first candidate code snippet is executed at a code execution environment (e.g., code execution environment 104) based on a unit test (e.g., unit tests 106) thereby producing a first feedback (e.g., correctness feedback 120) reflecting a correctness of the first candidate code snippet.

In some embodiments, the code execution environment includes a hardware environment based on one or more of a central processing unit (CPU), a graphics processing unit (GPU), or an application specific integrated circuit (ASIC).

In some embodiments, the generating of the first feedback includes executing the first candidate code snippet based on a testing input to generate a testing output, comparing the testing output with an expected value corresponding to the unit test, determining the first candidate code snippet pass the unit test in response to a difference between the testing output and the expected value being in a predetermined range, and determining the first candidate code snippet fails the unit test in response to the difference between the testing output and the expected value being outside the predetermined range.

In some embodiments, the first feedback takes a form of one or more of a pass of the unit test, an execution failure, a syntax error, a program error, or a timeout error of the unit test. In response to a failure feedback, method 500 further includes, generating, by the neural network based language model, a corrected first candidate code snippet based on an updated input prompt combining the first feedback, the first candidate code snippet, and the natural language problem description. Method 500 further includes, executing, at the code execution environment, the corrected first candidate code snippet based on the unit test thereby producing an updated first feedback reflecting a correctness of the corrected first candidate code snippet.

At step 508, the neural network based language model generates a second candidate code snippet (e.g., candidate code snippet 122) based on a second input prompt combining the natural language problem description, the first candidate code snippet, and the first feedback (e.g., at step 5).

At step 510, the second candidate code snippet is executed at the code execution environment based on a runtime test thereby producing a second feedback (e.g., performance feedback 124) reflecting a runtime efficiency of the second candidate code snippet.

In some embodiments, the runtime test includes measuring an execution time consumed by the second candidate code snippet based on the unit test.

In some embodiments, method 500 further includes re-validating a correctness of a neural network generated code output. The revalidation includes executing, at the code execution environment, the second candidate code snippet based on the unit test thereby producing a third feedback reflecting a correctness of the second candidate code snippet.

In some embodiments, method 500 further includes, in response to repeatedly receiving a negative feedback on correctness after a pre-defined quantity of regeneration, measuring execution times of generated candidate code snippets based on the unit test. Method 500 may further include selecting a candidate code snippet having a shortest execution time.

At step 512, the neural network based language model generates a third candidate code snippet (e.g., performant code snippet 116) based on a third input prompt (e.g., prompt 126) combining the natural language problem description, the second candidate code snippet, and the second feedback.

At step 514, the third candidate code snippet is executed at an application associated with the natural language problem description.

In some embodiments, multiple candidate code snippets are executed based on the runtime tests, each producing a respective runtime efficiency metric. Method 500 further includes selecting one of the multiple candidate code snippets with a highest runtime efficiency metric and a corresponding feedback as part of the third input prompt.

In some embodiments, the natural language problem description includes a description of detecting a network anomaly amongst incoming packets. The executing the third candidate code snippet at the application associated with the natural language problem description includes identifying one or more malicious network packets from an incoming network traffic based on an execution of the third candidate code snippet at a gateway application, and filtering the identified one or more malicious network packets at the gateway application.

In one embodiment, method 500 is applicable in a variety of applications. For example, the task request (e.g., problem description 114) received by a neural network model (e.g., Phi, Llama, Mixtral, Command R, GPT-3.5, GPT-4, etc.) may relate to generating software code to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like. Method 500 generates a code with improved accuracy and execution efficiency to address the requests in different technical fields.

For example, when the problem description 114 includes a request to write an information technology (IT) anomaly diagnostic program relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

In some embodiments, method 500 further includes generating, by at least one Application-Specific Integrated Circuit (ASIC) performing a multiplicative and/or accumulative operation for a neural network language model, a next token; and generating a natural language output representing one or more of the first candidate code snippet, the second candidate code snippet, or the third candidate code snippet combining a sequence of generated tokens.

In some embodiments, the natural language problem description includes a query to identify an information technology (IT) anomaly relating to a usage of an IT component. Method 500 may further include determining that an updated action execution state representing an information technology anomaly, causing an alert relating to the information technology anomaly to be displayed at a visualized user interface.

### EXAMPLE RESULTS

FIGS. 6A, 6B, and 7-9 represent exemplary test results using embodiments described herein.

To evaluate the correctness and runtime-efficiency of LLM generated solutions (e.g., code snippets) using different approaches, work by Madaan et al. (Aman Madaan, Alexander Shypula, Uri Alon, Milad Hashemi, Parthasarathy Ranganathan, Yiming Yang, Graham Neubig, and Amir Yazdanbakhsh, “Learning performance-improving code edits,” CoRR, abs/2302.07867, 2023.) is followed to compute and report the below metrics using the fastest (Best@ k) LLM generated correct program out of k samples.

First, percent optimized [% Opt] is determined. Percent optimized is computed as the proportion of problems in the test set where the fastest correct LLM generated program yₓ is more runtime-efficient (at least 10% faster) than the ground truth

$${g}_{x} \cdot \frac{100}{N} \cdot {\sum }_{x} {𝕝}_{{\sum }_{j} \hat{t} ( {y}_{x} , {u}_{x}^{j} ) < 0.9 \cdot {\sum }_{j} \hat{t} ( {g}_{x} , {u}_{x}^{j} )}$$

where N is the total number of test set problems.

Second, percent correct [% Correct] is determined. Percent correct is computed as the proportion of problems in the test set where the LLM generates at least one correct solution out of k candidates.

Further, speedup is determined. For problems where at least one correct LLM-generated program yₓ is obtained, the speedup is calculated as the absolute ratio between the execution time required by gₓ and the execution time required by the fastest correct yₓ.

$$\frac{{\sum }_{x} {\sum }_{j} \hat{t} ( {g}_{x} , {u}_{x}^{j} )}{{\sum }_{x} {\sum }_{j} \hat{t} ( {y}_{x} , {u}_{x}^{j} )} .$$

Following work by Singhal et al. (Manav Singhal, Tushar Aggarwal, Abhijeet Awasthi, Nagarajan Natarajan, and Aditya Kanade, “Nofuneval: Funny how code 1 ms falter on requirements beyond functional correctness”, 2024.), an empirical estimation of the execution time of Python programs is used. While tools like the gem5 simulator disclosed by Binkert et al. (Nathan Binkert, Bradford Beckmann, Gabriel Black, Steven K Reinhardt, Ali Saidi, Arkaprava Basu, Joel Hestness, Derek R Hower, Tushar Krishna, Somayeh Sardashti, et al., “The gem5 simulator”, ACM SIGARCH computer architecture news, 39(2):1-7, 2011.) for reliably and efficiently determine central processing unit (CPU) cycles of a program, adapting them for Python is non-trivial. Nevertheless, the qualitative analysis confirms that the differences observed in execution time (\hat{t}) correspond to clear differences in coding patterns. To estimate the execution time of a candidate solution/code snippet, use E=12 executions is used for each unit test as described in Equation (1). Then the above three metrics are computed using the fastest correct program yₓ obtained from k (Best@k) candidates. If there are multiple ground truth solutions (like in APPS), only the fastest one as the reference is used for computing all metrics. The impact of sampling budget on the effectiveness of the code generation framework is studied by using k ∈ {1, 8, 20}.

The analysis is performed by treating % Opt as the preferred metric over speedup when comparing different methods. A method achieving higher % Opt would be generally more desirable to users than one with lower % Opt, irrespective of speedups observed. This is because users often prefer a larger number of tasks solved optimally rather than a few tasks solved more optimally. However, this preference can be adjusted based on user requirements in different contexts. Speedup should only be analyzed in conjunction with % Opt and % Correct, not in isolation, as it is defined using problems with a correctly generated program by the LLM. Note that the % Correct metric is equivalent to the commonly reported pass@ k, when n=k. However, since the approach of the disclosure leverages unit tests in execution feedback, it is not suitable to compare the correctness metric with those from previous works by Shinn et al. (Noah Shinn, Federico Cassano, Ashwin Gopinath, Karthik Narasimhan, and Shunyu Yao, “Reflexion: Language agents with verbal reinforcement learning’, Advances in Neural Information Processing Systems, 36, 2024.) that do not assume access to unit tests, and instead reserve them for correctness evaluation. The disclosure presents an alternative formulation where generating a program with optimal runtime efficiency is being sought, given all unit tests for a task. The proposed framework can nonetheless be applied in settings where no unit tests are included, by generating synthetic unit tests for a problem using LLMs by Chen et al. (Bei Chen, Fengji Zhang, Anh Nguyen, Daoguang Zan, Zeqi Lin, Jian-Guang Lou, and Weizhu Chen, “Codet: Code generation with generated tests”, 2022.) and Shinn et al. For simplicity, HumanEval, MBPP and APPS datasets, which include tests commonly used to evaluate LLMs on programming tasks, are re-purposed. The present disclosure include open LLMs of varying sizes as the neural network based language model 102: Phi-3-mini 3.8B by Abdin et al. (Marah Abdin, Sam Ade Jacobs, Ammar Ahmad Awan, Jyoti Aneja, Ahmed Awadallah, Hany Awadalla, Nguyen Bach, Amit Bahree, Arash Bakhtiari, Harkirat Behl, et al., “Phi-3 technical report: A highly capable language model locally on your phone”, 2024), Llama 3 8B (Meta), Mixtral 8×7B (13B active params by Albert Q Jiang, Alexandre Sablayrolles, Antoine Roux, Arthur Mensch, Blanche Savary, Chris Bamford, Devendra Singh Chaplot, Diego de las Casas, Emma Bou Hanna, Florian Bressand, et al., “Mixtral of experts”, 2024.), Command R (Cohere), Llama 3 70B (Meta). The closed and commercial GPT-3.5 (Long Ouyang, Jeffrey Wu, Xu Jiang, Diogo Almeida, Carroll Wainwright, Pamela Mishkin, Chong Zhang, Sandhini Agarwal, Katarina Slama, Alex Ray, et al., “Training language models to follow instructions with human feedback. Advances in neural information processing systems”, 2022.) and GPT-4 models via OpenAI APIs, are included.

FIG. 6A shows the performance of different LLMs on problems from the HumanEval and MBPP benchmarks using the disclosed code generation framework (e.g., code generation framework 100) and the aforementioned metrics, with a sampling budget of k=1 and 8 samples. For comparison, the base LLM performance without using the code generation framework is also shown. In FIG. 6A, gains in % Opt and % Correct observed by applying the code generation framework are indicated in the relevant cells (+δ,−δ) for each model. The code generation framework generates correct and runtime-efficient programs for more problems than base LLM. Despite the higher correctness rate, the code generation framework maintains similar speedup, i.e., speedup over more samples, demonstrating its ability to generate runtime-efficient solutions for more challenging problems that the base LLM may not solve optimally. Performance results with a k of 20 are provided in FIG. 6B. On both the benchmarks, it is shown that the disclosed code generation framework leads to significant improvements in % Opt and % Correct for all base LLMs, particularly with the higher k of 8.

With The code generation framework, the runtime-efficiency of programs generated by open models like Phi-3-mini (% Opt of 40.85@k=8) and Llama 3 70B (39.02) are noticeably enhanced, making them comparable to GPT-4 in the base setting, which attains the highest base % Opt of 39.26 (k=8). Similarly, with the code generation framework, open models like Mixtral (27.67), Command R (32.52) and Llama 3 8B (31.10) can achieve comparable % Opt to GPT-3.5 (29.63). While the performance of open models can be elevated to match that of closed commercial models, even higher gains in % Opt and % Correct are shown when using the code generation framework on the closed GPT-3.5 and GPT-4 models. This finding can be attributed to the differences in the reasoning capabilities of these model categories, as the effectiveness of the code generation framework heavily relies on the reasoning skills of the given LLM.

On MBPP, significant gains in % Opt is continuously shown when using the code generation framework in most cases when sampling 8 candidates. An exception is Llama 3 70B, whose performance marginally drops on MBPP with the disclosed method at k=1, likely due to the high variance in estimating % Opt with a single sample. This drop can be mitigated in practice by leveraging execution time evaluation to fall back to the base LLM output if the disclosed refinement is correct but suboptimal. However, this is avoided for a stricter evaluation of the disclosed scheme. An example is shown below where the code generation framework generates a faster program than the ground truth. As shown in FIG. 6A, a majority of LLMs generate solutions that are faster than the ground truth for significant portions of the test set, raising questions about their optimality.

Problem: Write a python function to find the average of cubes of first n natural numbers.

```
# Optimal solution generated by \ tool based on GPT-4:
def solution(n):
  sum_of_cubes = (n*(n + 1) / 2.0)**2
  return sum_of_cubes/n
# Original ground truth solution in MBPP:
def solution(n):
    sum = 0
    for i in range(1, n + 1):
      sum += i*i*i
    return round(sum / n, 6)
```

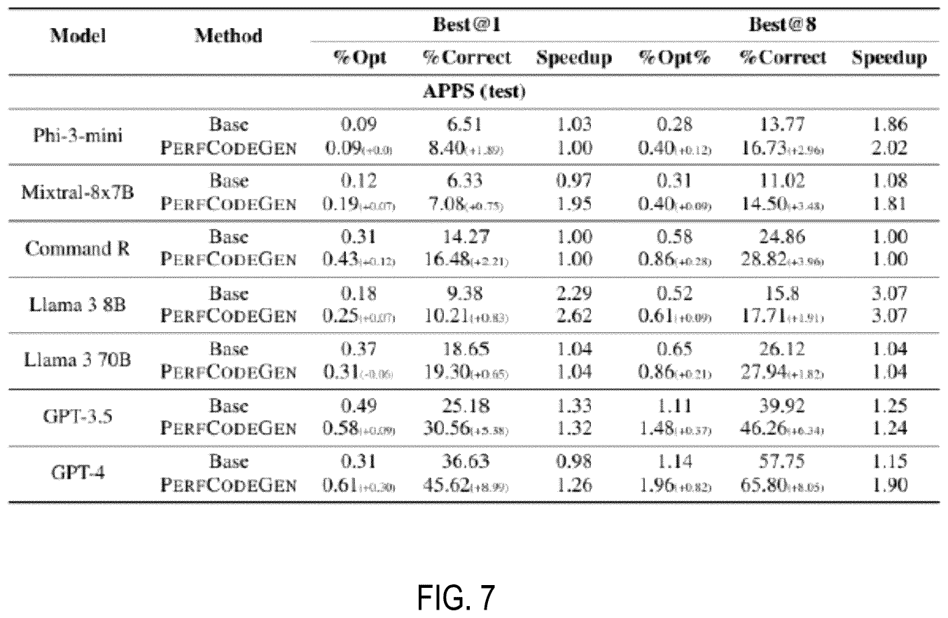

Results on the APPS dataset are reported in FIG. 7, which shows gains in % Opt and % Correct observed by applying the code generation framework are indicated in the relevant cells (+δ,−δ) for each model. The code generation framework generates correct and runtime-efficient programs for more problems than the base LLM. Despite the higher relative correctness rate, the code generation framework maintains similar speedup, i.e., speedup over more samples. While the absolute % Opt and % Correct on APPS problems are lower due to the higher difficulty level of problems, the code generation framework offers sizeable relative gains on both these metrics. A significantly lower correctness rate is observed compared to HumanEval and MBPP with all LLMs, which is expected given the higher difficulty of APPS. Additionally, since each problem in this dataset has on average more than 25 ground truth solutions, and the best one is used as the reference for comparison, most models fail to generate a solution more optimal than the best ground truth reference for over 1% of the dataset with a k of 1. Using the code generation framework's execution feedback, gains in % Opt, % Correct and speedup of GPT-3.5 and GPT-4 generations on APPS-test problems are observed, whereas open models benefit less due to task difficulty and their limited reasoning skills. Notably, the gap in correctness rates between commercial GPT models and open models is significantly wider on APPS than on simpler problems from HumanEval and MBPP, highlighting the capability differences.

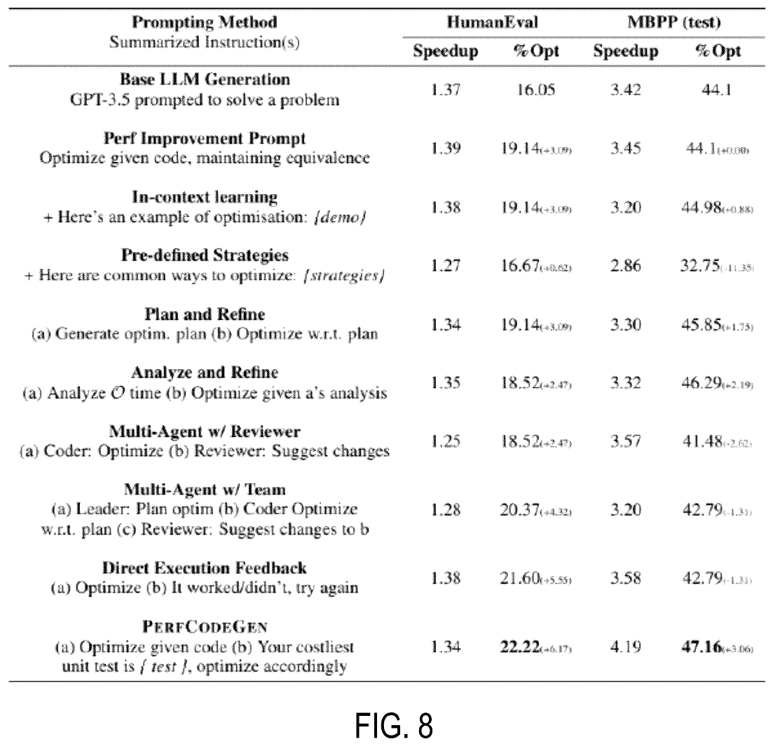

Given a correct solution, some common prompting techniques for the performance improvement phase are evaluated. Examples of prompts are provided in FIGS. 4A-4E. FIG. 8 shows lists the results with all these methods on the HumanEval and MBPP datasets using GPT-3.5. FIG. 8 shows the comparison between the code generation framework with alternatives in the Performance-Refinement State (k=1) using GPT-3.5. Gains in % OPT are denoted by +δ or −δ in the respective cells. The execution feedback of the code generation framework demonstrates the highest gains while maintaining a similar speedup. Other models are excluded from this analysis to avoid the high costs associated with LLM inference. Due to the significantly larger size of the APPS-test set compared to HumanEval and MBPP, it is excluded from this comparative analysis to limit inference costs. APPS-test contains roughly 20× more problems, each with approximately three times as many test cases on average, making it prohibitively expensive to perform a comprehensive analysis with multiple LLMs.

It is started with three single-round prompting methods. First, vanilla prompting is used for performance improvement, instructing the LLM to optimize the correct code while ensuring functional equivalence (Appendix FIG. 4(a)). Next, a 3-Shot In-context learning baseline is evaluated, which includes three examples of program refinements along with optimization instructions (Appendix FIG. 4(b)). An improved prompt that includes common Python optimization tricks as predefined strategies is also assessed, along with the usual optimization instruction (Appendix FIG. 4(c)). Two multi-round approaches similar to those in Madaan et al. and Nye et al. (Maxwell Nye, Anders Johan Andreassen, Guy Gur-Ari, Henryk Michalewski, Jacob Austin, David Bieber, David Dohan, Aitor Lewkowycz, Maarten Bosma, David Luan, et al., “Show your work: Scratchpads for intermediate computation with language models”, 2021.) are also considered. In the Plan and Refine approach, the LLM is prompted to generate a plan for performance refinement, then prompted again with this output to implement the proposed refinement. In Analyze and Refine, the LLM is prompted to first analyze the time complexity, then prompt it again to refine the code based on this analysis.

Multi-agent prompting is also evaluated. First, a multi-agent coder-reviewer setup is implemented for performance refinement, where a coder refines the base solution and a reviewer provides feedback, followed by another refinement attempt based on this feedback. Additionally, a more elaborate variant is implemented with leader-coder-reviewer roles, where the three agents take turns planning, refining, and reviewing code. Finally, two variants are implemented leveraging execution feedback for performance improvements after the LLM attempts to refine the correct code solution. In the first variant, the effectiveness of the refinement and verbalize the result (positive if the refinement is faster than the base, negative otherwise) are executed and evaluated, feeding this feedback to the LLM for another refinement attempt. In the code generation framework, the most time-consuming unit test is provided as feedback to the LLM.

From FIG. 8, it is observed that the base model generations offer significant performance optimizations over the ground truth. However, the gains with performance-improvement prompting, multi-round, and multi-agent techniques are insignificant and often negative. This can be attributed to cascading LLM reasoning errors. Direct execution feedback produces mixed results, with a % Opt gain of 5.55% on HumanEval and a drop of 1.31% on MBPP. In contrast, the code generation framework results in substantial gains in optimization rate on HumanEval (6.17% gain in % Opt) and MBPP (3.06% gain in % Opt) problems, validating the higher performance-improvement effectiveness of the code generation framework's execution feedback, in the form of the most expensive unit test.

The effectiveness of the code generation framework's planning step is evaluated in achieving higher correctness compared to directly using execution feedback. A high correctness rate is essential for generating optimized solutions effectively across a larger proportion of test set problems. The code generation framework is more likely to produce maximally optimal solutions by refining from a larger pool of correct candidate solutions, benefiting from the greater diversity within the seed set.

The (direct) Testcase Feedback approach is implemented as follows: starting with the base LLM generation, the correctness is evaluated based on available unit tests and instruct the LLM to refine its solution according to the environment output. This process mirrors how a developer would verify correctness by executing a program to ensure it passes the test suite. In contrast, the code generation framework incorporates an additional planning step based on verbalized environment output. The generated plan is then included in the prompt for refinement in the subsequent step.

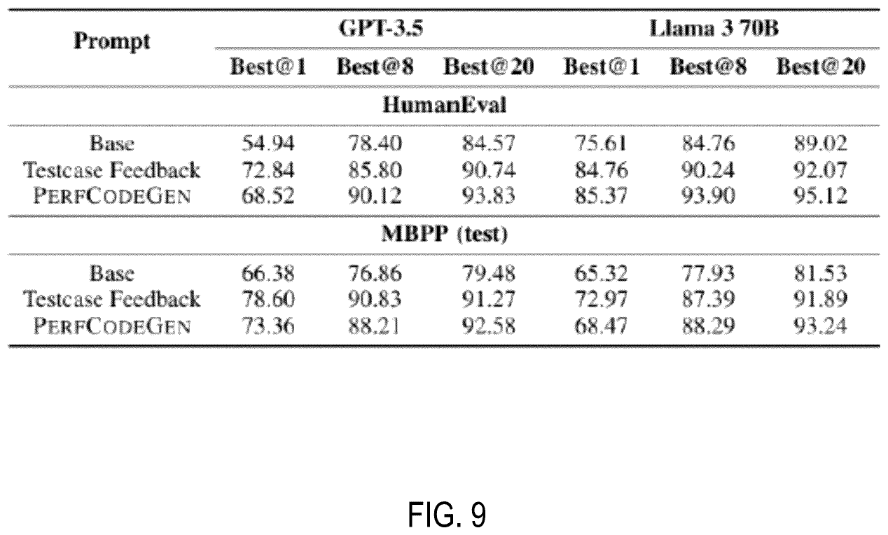

Results with these two approaches are shown in FIG. 9 on the HumanEval and MBPP datasets with GPT-3.5 and Llama 3 70B. Both approaches achieve higher correctness than the base LLM. With a k of 1, it is observed that the additional planning step of the code generation framework often leads to slightly lower correctness gain compared to the direct approach. However, with a k of 8 and 20, it is generally observed higher correctness rate with the planning step. Notably, the code generation framework achieves the highest correctness rates on both benchmarks, underscoring the utility of its additional planning step, suggesting this should also be included in the performance phase given additional token budget.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of generating a code output in response to a natural language problem description, comprising:
receiving, via a communication interface, the natural language problem description;
generating, by a neural network based language model, a first candidate code snippet based on a first input prompt combining the natural language problem description and a first instruction to generate the code output;
executing, at a code execution environment, the first candidate code snippet based on a unit test thereby producing a first feedback reflecting a correctness of the first candidate code snippet;
generating, by the neural network based language model, a second candidate code snippet based on a second input prompt combining the natural language problem description, the first candidate code snippet, and the first feedback;
executing, at the code execution environment, the second candidate code snippet based on a runtime test thereby producing a second feedback reflecting a runtime efficiency of the second candidate code snippet;
generating, by the neural network based language model, a third candidate code snippet based on a third input prompt combining the natural language problem description, the second candidate code snippet, and the second feedback; and
executing the third candidate code snippet at an application associated with the natural language problem description.

2. The method of claim 1, wherein the generating of the first feedback comprises:
executing the first candidate code snippet based on a testing input to generate a testing output;
comparing the testing output with an expected value corresponding to the unit test;
determining the first candidate code snippet pass the unit test in response to a difference between the testing output and the expected value being in a predetermined range; and
determining the first candidate code snippet fails the unit test in response to the difference between the testing output and the expected value being outside the predetermined range.

3. The method of claim 1, wherein the first feedback takes a form of one or more of a pass of the unit test, an execution failure, a syntax error, a program error, or a timeout error of the unit test, and in response to a failure feedback, the method further comprises:
generating, by the neural network based language model, a corrected first candidate code snippet based on an updated input prompt combining the first feedback, the first candidate code snippet, and the natural language problem description; and
executing, at the code execution environment, the corrected first candidate code snippet based on the unit test thereby producing an updated first feedback reflecting a correctness of the corrected first candidate code snippet.

4. The method of claim 1, wherein the runtime test includes measuring an execution time consumed by the second candidate code snippet based on the unit test.

5. The method of claim 1, further comprising:
revalidating a correctness of a neural network generated code output, wherein the revalidation comprises:
executing, at the code execution environment, the second candidate code snippet based on the unit test thereby producing a third feedback reflecting a correctness of the second candidate code snippet.

6. The method of claim 5, further comprising:
in response to repeatedly receiving a negative feedback on correctness after a pre- defined quantity of regeneration:
measuring execution times of generated candidate code snippets based on the unit test; and
selecting a candidate code snippet having a shortest execution time.

7. The method of claim 1, wherein multiple candidate code snippets are executed based on the runtime test, each producing a respective runtime efficiency metric, and the method further comprises:
selecting one of the multiple candidate code snippets with a highest runtime efficiency metric and a corresponding feedback as part of the third input prompt.

8. The method of claim 1, wherein the code execution environment comprises a hardware environment based on one or more of a central processing unit (CPU), a graphics processing unit (GPU), or an application specific integrated circuit (ASIC).

9. A system for generating a code output in response to a natural language problem description, the system comprising:
a memory that stores a neural network based language model and a plurality of processor executable instructions;
a communication interface that receives the natural language problem description; and
one or more hardware processors that read and execute the plurality of processor- executable instructions from the memory to perform operations comprising:
generating, by the neural network based language model, a first candidate code snippet based on a first input prompt combining the natural language problem description and a first instruction to generate the code output;
executing, at a code execution environment, the first candidate code snippet based on a unit test thereby producing a first feedback reflecting a correctness of the first candidate code snippet;
generating, by the neural network based language model, a second candidate code snippet based on a second input prompt combining the natural language problem description, the first candidate code snippet, and the first feedback;
executing, at the code execution environment, the second candidate code snippet based on a runtime test thereby producing a second feedback reflecting a runtime efficiency of the second candidate code snippet;
generating, by the neural network based language model, a third candidate code snippet based on a third input prompt combining the natural language problem description, the second candidate code snippet, and the second feedback; and
executing the third candidate code snippet at an application associated with the natural language problem description.

10. The system of claim 9, wherein the generating of the first feedback comprises:
executing the first candidate code snippet based on a testing input to generate a testing output;
comparing the testing output with an expected value corresponding to the unit test;
determining the first candidate code snippet pass the unit test in response to a difference between the testing output and the expected value being in a predetermined range; and
determining the first candidate code snippet fails the unit test in response to the difference between the testing output and the expected value being outside the predetermined range.

11. The system of claim 9, wherein the first feedback takes a form of one or more of a pass of the unit test, an execution failure, a syntax error, a program error, or a timeout error of the unit test, and in response to a failure feedback, the operations further comprise:
generating, by the neural network based language model, a corrected first candidate code snippet based on an updated input prompt combining the first feedback, the first candidate code snippet, and the natural language problem description; and
executing, at the code execution environment, the corrected first candidate code snippet based on the unit test thereby producing an updated first feedback reflecting a correctness of the corrected first candidate code snippet.

12. The system of claim 9, wherein the runtime test includes measuring an execution time consumed by the second candidate code snippet based on the unit test.

13. The system of claim 9, wherein the operations further comprise:
revalidating a correctness of a neural network generated code output, wherein the revalidation comprises:
executing, at the code execution environment, the second candidate code snippet based on the unit test thereby producing a third feedback reflecting a correctness of the second candidate code snippet.

14. The system of claim 13, wherein the operations further comprise:
in response to repeatedly receiving a negative feedback on correctness after a pre- defined quantity of regeneration:
measuring execution times of generated candidate code snippets based on the unit test; and
selecting a candidate code snippet having a shortest execution time.

15. The system of claim 9, wherein multiple candidate code snippets are executed based on the runtime test, each producing a respective runtime efficiency metric, and the operations further comprise:
selecting one of the multiple candidate code snippets with a highest runtime efficiency metric and a corresponding feedback as part of the third input prompt.

16. The system of claim 9, wherein the code execution environment comprises a hardware environment based on one or more of a central processing unit (CPU), a graphics processing unit (GPU), or an application specific integrated circuit (ASIC).

17. A non-transitory machine-readable medium comprising a plurality of machine-executable instructions which, when executed by one or more processors, are adapted to cause the one or more processors to perform operations comprising:
receiving, via a communication interface, a natural language problem description;
generating, by a neural network based language model, a first candidate code snippet based on a first input prompt combining the natural language problem description and a first instruction to generate the code output;
executing, at a code execution environment, the first candidate code snippet based on a unit test thereby producing a first feedback reflecting a correctness of the first candidate code snippet;
generating, by the neural network based language model, a second candidate code snippet based on a second input prompt combining the natural language problem description, the first candidate code snippet, and the first feedback;
executing, at the code execution environment, the second candidate code snippet based on a runtime test thereby producing a second feedback reflecting a runtime efficiency of the second candidate code snippet;
generating, by the neural network based language model, a third candidate code snippet based on a third input prompt combining the natural language problem description, the second candidate code snippet, and the second feedback; and
executing the third candidate code snippet at an application associated with the natural language problem description.

18. The non-transitory machine-readable medium of claim 17, wherein the generating of the first feedback comprises:
executing the first candidate code snippet based on a testing input to generate a testing output;
comparing the testing output with an expected value corresponding to the unit test;
determining the first candidate code snippet pass the unit test in response to a difference between the testing output and the expected value being in a predetermined range; and
determining the first candidate code snippet fails the unit test in response to the difference between the testing output and the expected value being outside the predetermined range.

19. The non-transitory machine-readable medium of claim 17, wherein the first feedback takes a form of one or more of a pass of the unit test, an execution failure, a syntax error, a program error, or a timeout error of the unit test, and in response to a failure feedback, the method further comprises:
generating, by the neural network based language model, a corrected first candidate code snippet based on an updated input prompt combining the first feedback, the first candidate code snippet, and the natural language problem description; and
executing, at the code execution environment, the corrected first candidate code snippet based on the unit test thereby producing an updated first feedback reflecting a correctness of the corrected first candidate code snippet.

20. The non-transitory machine-readable medium of claim 17, wherein the runtime test includes measuring an execution time consumed by the second candidate code snippet based on the unit test.
